(19) United States
(12) Patent Application Publication
(10) Pub. No.: US 2017/0093776 A1
(43) Pub. Date: Mar. 30, 2017

(54) CONTENT REDACTION

(71) Applicant: International Business Machines Corporation, Armonk, NY (US)

(72) Inventor: Bret W. Dixon, South Perth (AU)

(21) Appl. No.: 14/870,171

(22) Filed: Sep. 30, 2015

(51) Int. Cl. H04L 12/58

(52) U.S. Cl. CPC H04L 51/16; H04L 51/14

(57) ABSTRACT

A computer detects the draft of a message as well as flagged content within the message and emphasizes the flagged content within the copy of the drafter. The computer identifies which recipients receive the original message and which recipients receive a version of the message in which the flagged content is redacted. The computer detects when the drafter transmits the message and temporarily prevents message transmission to archive a copy of the original message within the outgoing mail box of the drafter and redact the flagged content from copies of the message transmitted to recipients only receiving the redacted version of the message. The computer then allows the message to be transmitted.

### TECHNICAL FIELD

The present invention relates generally to electronic communications, and more particularly to redacting non-distributable portions of electronic communications.

### BACKGROUND

Electronic communications, such as instant messaging and electronic mail (email), are vital aspects of modern day technology. While electronic messaging clients have a broad range of features that facilitate the composition and managing of electronic communications, one such feature that appears to be missing in current electronic messaging clients is the ability to include non-distributable information within a senders version of an electronic message but to remove the non-distributable content from the outgoing electronic messages. For example, a branch manager may draft an email summarizing a quarterly earnings report based on non-distributable or confidential raw data. While the branch manager would like to associate the email and raw data with each other within his own sent mail archive, the branch manager has no way of removing the non-distributable raw data from the outgoing emails. Rather, the branch manager must save the raw data separate from the email and reunite the two when referencing the quarterly earnings at a later time.

### SUMMARY

Embodiments of the present invention disclose a method, system, and computer program product for redacting message content. A computer detects the draft of a message as well as flagged content within the message and emphasizes the flagged content within the copy of the drafter. The computer identifies which recipients receive the original message and which recipients receive a version of the message in which the flagged content is redacted. The computer detects when the drafter transmits the message and temporarily prevents message transmission to archive a copy of the original message within the outgoing mail box of the drafter and redact the flagged content from copies of the message transmitted to recipients only receiving the redacted version of the message. The computer then allows the message to be transmitted.

### BRIEF DESCRIPTION OF THE SEVERAL VIEWS OF THE DRAWING

FIG. 1 illustrates a content redacting system 100, in accordance with an embodiment of the invention.

FIG. 2 is a flowchart illustrating the operations of the redacting program 114 of FIG. 1 in redacting content from a message such that it is visible to the sender and hidden from the recipient.

FIG. 3 is a block diagram depicting the hardware components of a content redacting system 100 of FIG. 1, in accordance with an embodiment of the invention.

### DETAILED DESCRIPTION

Embodiments of the present invention will now be described in detail with reference to the accompanying figures.

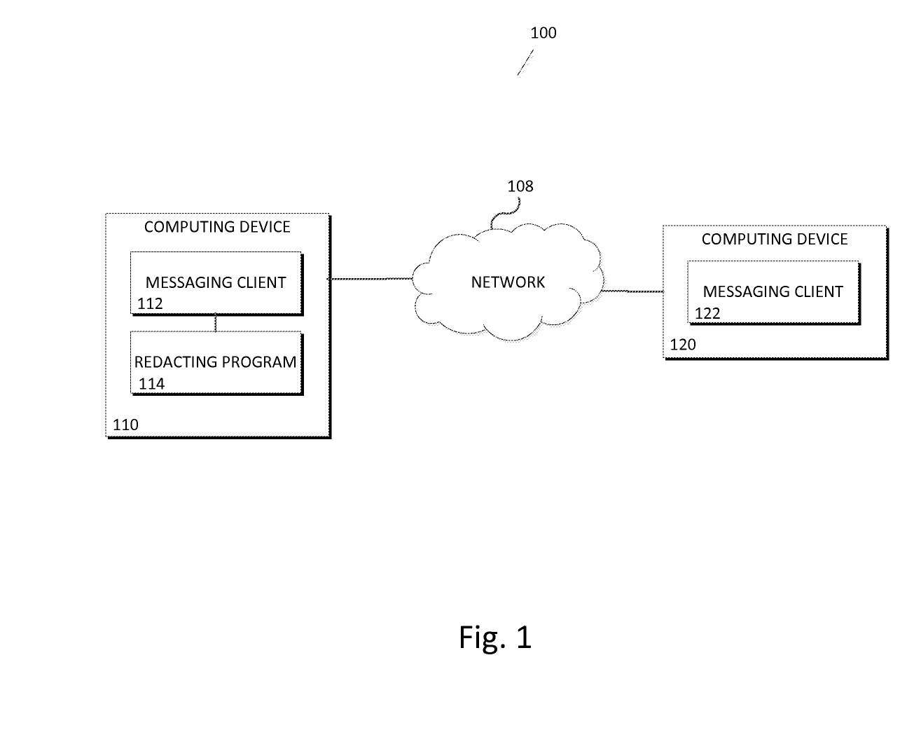

FIG. 1 illustrates a content redacting system 100, in accordance with an embodiment of the invention. In the example embodiment, content redaction system 100 includes computing device 110, network 108, and computing device 120.

In the example embodiment, network 108 may be the Internet, representing a worldwide collection of networks and gateways to support communications between devices connected to the Internet. Network 108 may include, for example, wired, wireless or fiber optic connections. In other embodiments, network 108 may be implemented as an intranet, a local area network (LAN), or a wide area network (WAN). In general, network 108 can be any combination of connections and protocols that will support communications between computing device 110 and computing device 120.

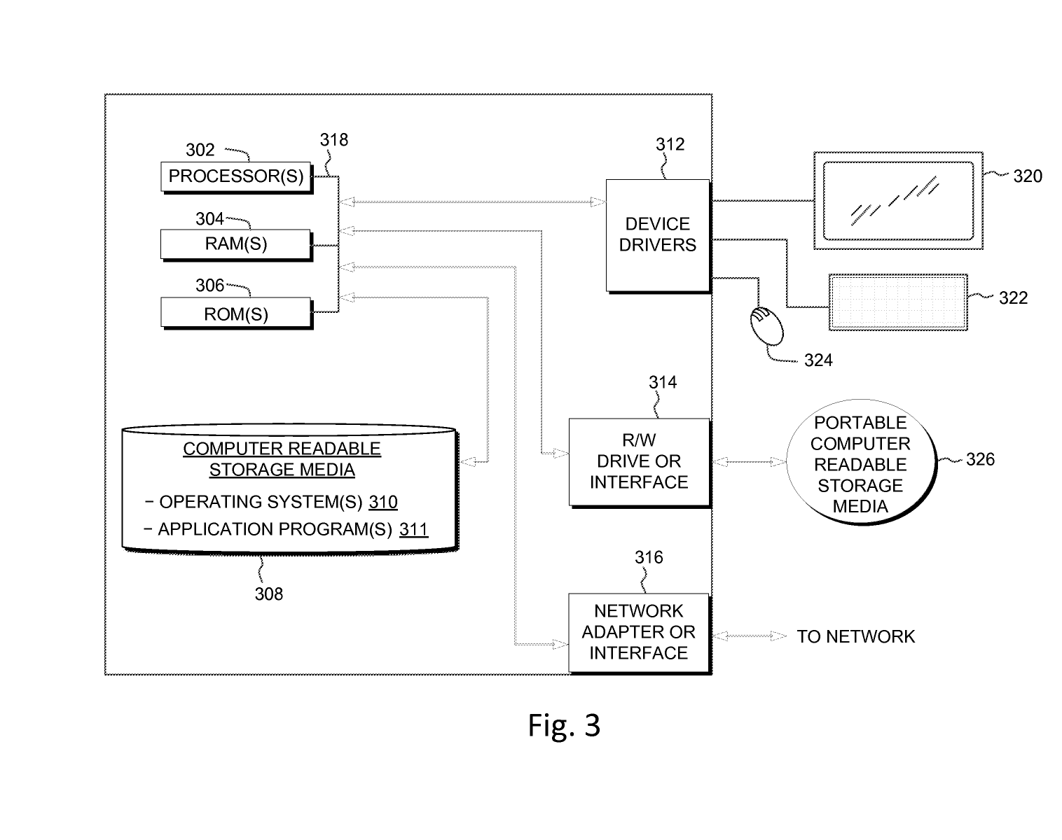

Computing device 120 includes messaging client 122. Computing device 120 may be a laptop computer, a notebook, tablet computer, netbook computer, personal computer (PC), a desktop computer, a personal digital assistant (PDA), a smart phone, a thin client, or any other electronic device or computing system capable of receiving and sending data to and from other computing devices. While computing device 120 is shown as a single device, in other embodiments, computing device 120 may be comprised of a cluster or plurality of computing devices, working together or working separately. Computing device 120 is described in further detail with reference to FIG. 3.

Messaging client 122 is a messaging program capable of transmitting electronic messages between devices. In the example embodiment, messaging client 112 is an electronic mail (e-mail) program and is integrated with redacting program 114, however, in other embodiments, messaging client 112 may be a stand-alone program. In other embodiments, messaging client 112 may be a program capable of hosting other forms of electronic messaging, such as instant messaging, files/document transfers, and web conferences.

Computing device 110 includes messaging client 112 and redacting program 114. In the example embodiment, computing device 110 may be a laptop computer, a notebook, tablet computer, netbook computer, personal computer (PC), a desktop computer, a personal digital assistant (PDA), a smart phone, a thin client, or any other electronic device or computing system capable of receiving and sending data to and from other computing devices. While computing device 110 is shown as a single device, in other embodiments, computing device 110 may be comprised of a cluster or plurality of computing devices, working together or working separately. Computing device 110 is described in more detail with reference to FIG. 3.

Messaging client 112 is a messaging program capable of transmitting electronic messages between devices. In the example embodiment, messaging client 122 is an electronic mail (e-mail) program, however, in other embodiments, messaging client 112 may be a program capable of hosting other forms of electronic messaging, such as instant messaging, files/document transfers, and web conferences.

In the example embodiment, redacting program 114 is a program integrated with messaging client 112 which is capable of detecting when a user has flagged content within a message draft, such as a message drafted in messaging client 112. Redacting program 114 is additionally capable of visually displaying the flagged content by emphasizing it through means such as highlighting or underlining. Redacting program 114 is further capable of detecting a user's request to transmit the message, such as a request to transmit the message from messaging client 112 to messaging client 122, using a network, such as network 108. Furthermore, redacting program 114 is capable of visually redacting, or obscuring, the flagged content within the outgoing message while displaying the flagged content unobscured within the senders version.

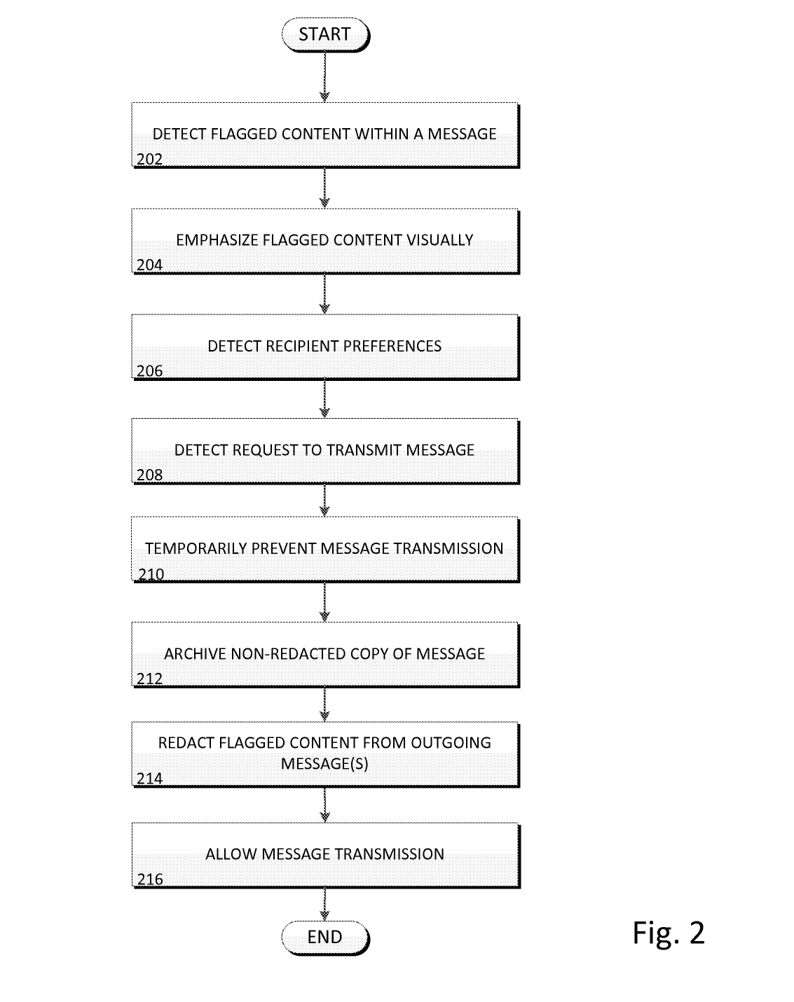

FIG. 2 is a flowchart depicting the operations of redacting program 114 in redacting flagged content from an outgoing electronic message while retaining the flagged content within the senders copy. Redacting program 114 detects the flagged content within a message by detecting a user input detailing a selection by the user of text that is to be redacted (step 202). In the example embodiment where redacting program 114 is integrated with messaging client 112, redacting program 114 detects a message and the selected (flagged) content within the message by monitoring the input received by messaging client 112. In the example embodiment, a user flags the content to be redacted by selecting (highlighting) the content within the message, right clicking on the selected content, and selecting an option to flag the selected content. In other embodiments, the option to flag selected content may be a button within a toolbar or an option selected from a drop down list within messaging client 112. In further embodiments, separate input fields within the user interface may denote which portions of the message are flagged for redaction and which are not. For example, if a branch manager flags non-distributable raw data in an email summarizing the quarterly earnings of the branch, then redacting program 114 detects that the raw data has been flagged by monitoring the user input for an indication that the branch manager has selected the flag content option.

Redacting program 114 emphasizes the flagged content visually (step 204). In the example embodiment, redacting program 114 emphasizes the flagged content within the draft of the message by applying a strikethrough to the content (ex. [symbol] ) such that it is visible to the drafter yet denoted as being redacted in the outgoing copies. In other embodiments, flagged content may be emphasized by highlights, coloring, different size text, underlining, bolding, italicizing, an asterisk, or another visual indication. In further embodiments, flagged content may be denoted by being relocated to a separate input field or being shown in a separate window. Continuing the example above, if redacting program 114 detects that the raw data has been flagged, then redacting program 114 emphasizes the raw data by applying to it a strikethrough.

Redacting program 114 detects recipient preferences which detail both the recipients of the message as well as which version (redacted or non-redacted) each recipient receives (step 206). In the example embodiment, redacting program 114 is capable of receiving a list of one or more individual recipients, predefined groups of recipients, and/or references to entire databases of recipients from which redacting program 114 is capable of determining which recipients receive a redacted version and which receive a non-redacted version. The predefined groups of recipients may be input by a user or administrator through a user interface on messaging client 112 while databases are mapped to the location and may include, for example, databases corresponding to company employees, social networks, and professional networks. In the example embodiment, redacting program 114 determines which recipients, whether redacting program 114 received a list of individual recipients or redacting program 114 references an entire database of recipients, receive a redacted or a non-redacted version of the message by distinguishing recipients using a distinguishing factor, or characteristic, defined by the user. In the example embodiment, a user defines the distinguishing factor of the recipients, such as seniority, security clearance level, department/division, job title, family, connections/contacts, network connections, location, etc. as well as the required qualification of said distinguishing factor by utilizing a dropdown list on the user interface of messaging client 112. Such qualifications may include seniority of a specific duration of time or position at a company, a specific security clearance level or higher, a department or division of legal or manufacturing, job title of attorney, connection to a specific wired or wireless network, etc. In the example embodiment, the qualification is the threshold that must be met or exceeded by the distinguishing factor possessed by the recipients in order for the recipient to receive a redacted or non-redacted version of the message. Furthermore, in the example embodiment, recipients may only be required to satisfy at least one of multiple qualifications associated with multiple distinguishing factors in order to receive a redacted or non-redacted version of the message. Redacting program 114 then references associated databases, such as employee databases, to ascertain the distinguishing factor of the listed recipients and determines, based on the distinguishing factor and qualification, whether or not the recipients receive a redacted or non-redacted version of the message. Distinguishing factors and qualifications may be configured to apply to any or all of the recipients listed within the recipient input field and multiple distinguishing factors and/or qualifications may be selected when applicable. In addition, default distinguishing factors and default qualifications can be assigned such that, for example, specific and/or most commonly used distinguishing factors and qualifications are selected when an email draft is created or recipients are added to the recipient input field. Alternatively, a user may also designate his/her qualification of the distinguishing factor as the threshold for receiving a non-redacted version of the message such that any recipients at the same qualification or higher receive a non-redacted version. Using the example above where a branch manager would like to send his employees a redacted version of the message while sending a non-redacted version of the message to his boss, if the branch manager inputs the entire employee database in the recipients list and configures the distinguishing factor of the recipients as band level (seniority) while configuring the qualification as his own level of band 6 or higher, then redacting program 114 references the associated employee database to determine that the recipient employees of the branch manager do not meet nor exceed band level 6 for a non-redacted version while the boss of the branch manager exceeds the qualification of band level 6. Redacting program 114 is similarly capable of determining which recipients get each version of the message if the branch manager input his employees and his boss into the recipient input field individually or in predefined groups so long as the branch manager selects one or more distinguishing factors and qualifications.

Similarly, redacting program 114 is further capable of identifying recipients and determining which recipients receive a redacted version of the message by referencing devices (laptops, smart phones, or global positioning systems (GPS)) as well as networks (WiFi networks, Bluetooth networks, Local Area Networks (LAN), etc.) in order to distinguish recipients based on geographic location or connection based criteria. Like selecting a distinguishing factor above, selecting a specific geographic location or connectivity as the threshold to receive a non-redacted version of the message is accomplished by the user by utilizing a dropdown menu within the user interface of messaging client 112. Furthermore, redacting program 114 is capable of combining multiple distinguishing factors such that, for example, only recipients connected to a specific network who also exceed a specific level of seniority receive a non-redacted version of the message.

In the example embodiment, redacting program 114 is further capable of determining the intended recipients of a message by utilizing optical character recognition and natural language processing to search the contents of the message for recipients and/or keywords. Keywords are specified by a user or administrator and are associated with the aforementioned individual recipients, predefined groups of recipients, or entire databases of recipients such that redacting program adds the associated recipients to the recipient list whenever redacting program 114 recognizes the associated keyword. Furthermore, when associating a keyword with an individual recipient, predefined group of recipients, or an entire database of recipients, a user may also designate whether the recipients associated with the keyword(s) receive a redacted or non-redacted version of the message. For example, if a user associates the keywords “data center” with the contact information of members within a data center and a non-redacted version of the message, then redacting program 114, upon identifying the keywords “data center” within the message, includes the contact information of associated data center members in the non-redacted message recipient list.

Furthermore, a user or administrator may similarly associate usernames and recipient names with recipient contact information such that redacting program 114 adds the contact information of the recipient to the recipient list whenever redacting program 114 recognizes an associated username or recipient name. Similar to how keywords may be associated with a redacted or non-redacted version of the message, a user or administrator may configure each recipient name or username such that redacting program 114 knows whether to transmit a redacted or non-redacted version of the message upon recognizing the username and/or recipient name. For example, if a user associates the recipient name Kam with the contact information of Kamyar Maserrat and a redacted version of the message, then redacting program 114, upon identifying the recipient name “Kam” in the message, includes the contact information of Kamyar Maserrat within the redacted message recipient list.

In other embodiments, the user interface of messaging client 112 may provide two recipient fields where one field details recipients/contact information of recipients who will receive the redacted version while the other field details recipients/contact information of those who are to receive the non-redacted version. In further embodiments, indicating whether a recipient receives a redacted or non-redacted version of the message may be performed by other means, such as checking a box next to the name/contact information of the recipient in a single recipient input field.

Redacting program 114 detects a request by a user to transmit the message by detecting user input received by messaging client 112 (step 208). In the example embodiment, a user requests to transmit the message by selecting the transmit button within the user interface of messaging client 112. In the example embodiment, the single transmit button of messaging client 112 will transmit the redacted and non-redacted message to recipients in both the redacted version recipient field as well as the non-redacted version recipient field, respectively. Continuing the example above, if redacting program 114 detects that the branch manager has selected the transmit button, then redacting program 114 allows messaging client 112 to transmit the redacted version of the message to his employees and the non-redacted version of the message to his boss. In other embodiments, a button to transmit a redacted version and a button to transmit a non-redacted version may be incorporated into the user interface of messaging client 112 such that the user has the option of transmitting the non-redacted version or redacted version depending on which transmit button they select. In such embodiments, messaging client 112 may utilize a single recipient input field and transmit the message to all recipients within that field based on the transmit button selected or utilize multiple recipient input fields corresponding to each transmit button.

Redacting program 114 temporarily prevents messaging client 112 from transmitting the message (step 210). In the example embodiment, upon detecting a request to transmit the message, redacting program 114 prevents messaging client 112 from transmitting the message temporarily while redacting program 114 archives a non-redacted version of the message, searches for flagged content, and redacts the flagged content within the message. In the example embodiment, redacting program 114 archives a version of the non-redacted message in the outgoing mailbox of the sender for future reference locally on computing device 110 (step 212). In other embodiments, redacting program 114 may archive a non-redacted version of the message remotely on a separate device or server. While the archived version maintains the strikethrough of flagged content to indicate to the sender which portions of the message have been redacted from the outgoing copies, the sender can remove the strikethrough by selecting a hide/show redacted content button within the user interface of messaging client 112. Redacting program 114 redacts the flagged content from the outgoing messages by obscuring the flagged content prior to transmission (step 214). The outgoing copies of the message which are marked for redaction are altered such that the flagged content is obscured within the recipient copies. In the example embodiment, flagged content is obscured by blurring the content until the content is unrecognizable. While the blurred content is unrecognizable in substance, the section of blurred content is an indication to the recipient that portions of the message are privileged. In other embodiments, redacted content may be blacked out completely or replaced with a statement indicating that the content has been redacted for confidentiality purposes. Indicating to a recipient that the content has been redacted may be advantageous in certain situations where a recipient is made aware the content exists, however the recipient is not privileged enough to access it. This notice allows a recipient, following receipt, to request access to the information if the situation warrants such. In further embodiments where recipients are intended to be unaware of the redacted content, flagged content may be removed all together from the recipient version, leaving no indication to the recipient that portions of content within the message has been redacted. Continuing the example above, if the branch manager selects the transmit button to send the message, then redacting program 114 temporarily prevents message transmission to archive a non-redacted version of the message within the outgoing mailbox of the branch manager (including the raw data with a strikethrough) and blurs the raw data within the outgoing messages selected for redaction. Furthermore, the branch manager may remove the strikethrough within his own, archived copy by selecting a hide/show redacted content button.

Redacting program 114 allows message transmission (step 216). In the example embodiment where redacting program 114 is integrated with messaging client 112, redacting program 114 allows messaging client 112 to transmit the redacted version to recipients listed within the redacted version recipient input field and the non-redacted version to recipients listed within the non-redacted version recipient input field. Continuing the example above where the branch manager has listed his employees in the redacted version recipient input list and his boss in the non-redacted version recipient input list, then redacting program 114 allows transmission of the redacted quarterly earnings report to the employees of the branch manager and allows the transmission of the non-redacted quarterly earnings report to the boss of the branch manager.

FIG. 3 depicts a block diagram of components of computing device 110 of a content redacting system 100 of FIG. 1, in accordance with an embodiment of the present invention. It should be appreciated that FIG. 3 provides only an illustration of one implementation and does not imply any limitations with regard to the environments in which different embodiments may be implemented. Many modifications to the depicted environment may be made.

Computing device 110 may include one or more processors 302, one or more computer-readable RAMs 304, one or more computer-readable ROMs 306, one or more computer readable storage media 308, device drivers 312, read/write drive or interface 314, network adapter or interface 316, all interconnected over a communications fabric 318. Communications fabric 318 may be implemented with any architecture designed for passing data and/or control information between processors (such as microprocessors, communications and network processors, etc.), system memory, peripheral devices, and any other hardware components within a system.

One or more operating systems 310, and one or more application programs 311, for example, redacting program 114, are stored on one or more of the computer readable storage media 308 for execution by one or more of the processors 302 via one or more of the respective RAMs 304 (which typically include cache memory). In the illustrated embodiment, each of the computer readable storage media 308 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Computing device 110 may also include a R/W drive or interface 314 to read from and write to one or more portable computer readable storage media 326. Application programs 311 on computing device 110 may be stored on one or more of the portable computer readable storage media 326, read via the respective R/W drive or interface 314 and loaded into the respective computer readable storage media 308.

Computing device 110 may also include a network adapter or interface 316, such as a TCP/IP adapter card or wireless communication adapter (such as a 4G wireless communication adapter using OFDMA technology). Application programs 311 on computing device 110 may be downloaded to the computing device from an external computer or external storage device via a network (for example, the Internet, a local area network or other wide area network or wireless network) and network adapter or interface 316. From the network adapter or interface 316, the programs may be loaded onto computer readable storage media 308. The network may comprise copper wires, optical fibers, wireless transmission, routers, firewalls, switches, gateway computers and/or edge servers.

Computing device 110 may also include a display screen 320, a keyboard or keypad 322, and a computer mouse or touchpad 324. Device drivers 312 interface to display screen 320 for imaging, to keyboard or keypad 322, to computer mouse or touchpad 324, and/or to display screen 320 for pressure sensing of alphanumeric character entry and user selections. The device drivers 312, R/W drive or interface 314 and network adapter or interface 316 may comprise hardware and software (stored on computer readable storage media 308 and/or ROM 306).

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Based on the foregoing, a computer system, method, and computer program product have been disclosed. However, numerous modifications and substitutions can be made without deviating from the scope of the present invention. Therefore, the present invention has been disclosed by way of example and not limitation.

Various embodiments of the present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for redacting content from a message, the method comprising:
detecting a message, wherein the message includes a portion of flagged content;
emphasizing the portion of flagged content visually;
identifying one or more recipients for the message, wherein the one or more recipients include a first group of recipients and a second group of recipients, and wherein the first group of recipients are associated with the portion of flagged content; and
transmitting the message to the one or more recipients, wherein the first group of recipients is transmitted the message including the portion of flagged content, and wherein the second group of recipients is transmitted the message with the portion of flagged content redacted,
wherein one or more steps of the above method are performed using one or more computers.

2. The method of claim 1, wherein the step of identifying the one or more recipients for the message further comprises:
identifying a user input detailing one or more distinguishing factors and one or more qualifications associated with the one or more distinguishing factors;
determining whether at least one of the one or more recipients satisfy at least one of the one or more qualifications associated with the one or more distinguishing factors; and
based on determining that at least one of the one or more recipients satisfy at least one of the one or more qualifications associated with the one or more distinguishing factors, adding the at least one of the one or more recipients to the first group of recipients.

3. The method of claim 1, wherein the step of identifying one or more recipients for the message further comprises:
identifying one or more keywords within the message, wherein each keyword of the one or more keywords corresponds to at least one of the one or more recipients; and
adding the at least one of the one or more recipients to the first group of recipients.

4. The method of claim 1, wherein the step of identifying one or more recipients for the message further comprises:
identifying identification information associated with at least one of the one or more recipients within the message; and
adding the at least one of the one or more recipients to the first group of recipients.

5. The method of claim 1, wherein the portion of flagged content is redacted by at least one of removing, blurring, and making indecipherable the portion of flagged content within the message.

6. The method of claim 2, wherein the one or more distinguishing factors includes a seniority, a security clearance level, a division, a job title, a network connection, a location, and wherein the one or more qualifications associated with the one or more distinguishing factors include a specific level of seniority, a specific security clearance level, a specific division, a specific job title, connection to a specific network, and being located in a specific location.

7. The method of claim 1, further comprising:
storing a first version of the message, wherein the first version of the message includes the portion of flagged content; and
storing a second version of the message, wherein the second version of the message has the portion of flagged content redacted.

8. A computer program product for redacting content from a message, the computer program product comprising:
one or more computer-readable storage media and program instructions stored on the one or more computer-readable storage media, the program instructions comprising:
program instructions to detect a message, wherein the message includes a portion of flagged content;
program instructions to emphasize the portion of flagged content visually;
program instructions to identify one or more recipients for the message, wherein the one or more recipients include a first group of recipients and a second group of recipients, and wherein the first group of recipients are associated with the portion of flagged content; and
program instructions to transmit the message to the one or more recipients, wherein the first group of recipients is transmitted the message including the portion of flagged content, and wherein the second group of recipients is transmitted the message with the portion of flagged content redacted.

9. The computer program product of claim 8, wherein the program instructions to identify the one or more recipients for the message further comprises:
program instructions to identify a user input detailing one or more distinguishing factors and one or more qualifications associated with the one or more distinguishing factors;
program instructions to determine whether at least one of the one or more recipients satisfy at least one of the one or more qualifications associated with the one or more distinguishing factors; and
based on determining that at least one of the one or more recipients satisfy at least one of the one or more qualifications associated with the one or more distinguishing factors, program instructions to add the at least one of the one or more recipients to the first group of recipients.

10. The computer program product of claim 8, wherein the program instructions to identify the one or more recipients for the message further comprises:
program instructions to identify one or more keywords within the message, wherein each keyword of the one or more keywords corresponds to at least one of the one or more recipients; and
program instructions to add the at least one of the one or more recipients to the first group of recipients.

11. The computer program product of claim 8, wherein the program instructions to identify the one or more recipients for the message further comprises:
program instructions to identify identification information associated with at least one of the one or more recipients within the message; and
program instructions to add the at least one of the one or more recipients to the first group of recipients.

12. The computer program product of claim 8, wherein the portion of flagged content is redacted by at least one of removing, blurring, and making indecipherable the portion of flagged content within the message.

13. The computer program product of claim 9, wherein the one or more distinguishing factors includes a seniority, a security clearance level, a division, a job title, a network connection, a location, and wherein the one or more qualifications associated with the one or more distinguishing factors include a specific level of seniority, a specific security clearance level, a specific division, a specific job title, connection to a specific network, and being located in a specific location.

14. The computer program product of claim 8, further comprising:
program instructions to store a first version of the message, wherein the first version of the message includes the portion of flagged content; and
program instructions to store a second version of the message, wherein the second version of the message has the portion of flagged content redacted.

15. A computer system for redacting content from a message, the computer system comprising:
one or more computer processors, one or more computer-readable storage media, and program instructions stored on one or more of the computer-readable storage media for execution by at least one of the one or more processors, the program instructions comprising:
program instructions to detect a message, wherein the message includes a portion of flagged content;
program instructions to emphasize the portion of flagged content visually;
program instructions to identify one or more recipients for the message, wherein the one or more recipients include a first group of recipients and a second group of recipients, and wherein the first group of recipients are associated with the portion of flagged content; and
program instructions to transmit the message to the one or more recipients, wherein the first group of recipients is transmitted the message including the portion of flagged content, and wherein the second group of recipients is transmitted the message with the portion of flagged content redacted.

16. The computer system of claim 15, wherein the program instructions to identify the one or more recipients for the message further comprises:
program instructions to identify a user input detailing one or more distinguishing factors and one or more qualifications associated with the one or more distinguishing factors;
program instructions to determine whether at least one of the one or more recipients satisfy at least one of the one or more qualifications associated with the one or more distinguishing factors; and
based on determining that at least one of the one or more recipients satisfy at least one of the one or more qualifications associated with the one or more distinguishing factors, program instructions to add the at least one of the one or more recipients to the first group of recipients.

17. The computer system of claim 15, wherein the program instructions to identify the one or more recipients for the message further comprises:
program instructions to identify one or more keywords within the message, wherein each keyword of the one or more keywords corresponds to at least one of the one or more recipients; and
program instructions to add the at least one of the one or more recipients to the first group of recipients.

18. The computer system of claim 15, wherein the program instructions to identify the one or more recipients for the message further comprises:
program instructions to identify identification information associated with at least one of the one or more recipients within the message; and
program instructions to add the at least one of the one or more recipients to the first group of recipients.

19. The computer system of claim 15, wherein the portion of flagged content is redacted by at least one of removing, blurring, and making indecipherable the portion of flagged content within the message.

20. The computer system of claim 15, further comprising:
program instructions to store a first version of the message, wherein the first version of the message includes the portion of flagged content; and
program instructions to store a second version of the message, wherein the second version of the message has the portion of flagged content redacted.
